(19) United States
(12) Patent Application Publication
(10) Pub. No.: US 2006/0157998 A1
(43) Pub. Date: Jul. 20, 2006

(54) Contamination-free edge gripping mechanism and method for loading/unloading and transferring flat objects

(76) Inventors: Elik Gershenzon, Daly City, CA (US); Boris Kesil, San Jose, CA (US)

Correspondence Address: Boris Kesil;Multimetrixs LLC., 1040 Di Giulio Avenue # 200, Santa Clara, CA, 95050, US

(21) Appl. No.: 11/036,870

(22) Filed: Jan. 18, 2005

(51) Int. Cl. B25J 15/08

(52) U.S. Cl. 294/103.1

(57) ABSTRACT

The griping mechanism of the present invention comprises a thin flat body having two linearly moveable side fingers and a pair of rotating and linearly moveable distal fingers. In contrast to gripper of conventional design, the gripping mechanism of the invention is positioned over the object. In spite of an overhead position, the gripper is contamination-free since it has a completely closed design. In the vicinity of the gripping fingers, the mechanism is provided with soft edge-supporting pads having tapered surfaces for self-alignment and centering of the circular objects. The pads also eliminate surface contact between the wafer and the surface of the gripper body. The overhead position of the gripper makes it possible to simplify the construction of a wafer-holding chuck, e.g., on wafer processing stations. The gripper has auxiliary object-uplifting means in the form of vacuum suction ports or blowing nozzles that generate a vortex effect for uplifting the objects to the level required for edge gripping.

### CROSS-REFERENCES TO RELATED APPLICATIONS

The present patent application is related to U.S. patent application Ser. No. 09/944,605 filed by B. Kesil, et al. on Sep. 4, 2001 and entitled “Precision Soft-Touch Gripping Mechanism for Flat Objects and to U.S. patent application Ser. No. 10/719,411 filed by B. Kesil et al., on Nov. 24, 2003 which is a continuation-in-part of aforementioned U.S. patent application Ser. No. 09/944,605, which is entitled “Soft-Touch Gripping Mechanism for Flat Objects”.

### FIELD OF THE INVENTION

The present invention relates to the field of material handling equipment, in particular to mechanisms and methods used in semiconductor production, disk-drive manufacturing industry and the like for precision gripping, transferring, and positioning delicate, thin and highly accurate flat objects such as semiconductor wafers, hard disks, etc. More specifically, the present invention relates to an edge gripping mechanism for transferring semiconductor wafer substrates, e.g., between a FOUP (front opening unified pod) or another substrate storage and a wafer processing station, or the like. The mechanism of the invention may be especially useful for loading/unloading semiconductor wafers or wafer substrates into/from storage cassettes with narrow spaces between parallelly stacked wafers stored in the cassette and for transferring the wafers or substrates between the storage cassette and the wafer/substrate chuck of a processing station.

### BACKGROUND OF THE INVENTION

From the beginnings of the semiconductor industry to the late 1980s, wafers were handled manually and later by rubber-band conveyors and cassette elevators. The first standards for wafer of 2″, 4″, 6″ diameters and appropriate cassette dimensions allowed to develop simple wafer handling mechanisms and standardize their designs. The early forms of automated handling contributed to improved yields by reducing wafer breakage and particle contamination. A variety of equipment layouts were used, but the general conception remained the same. In other words, the automation systems of that time relied mostly on stepper-motor-driven conveyor belts and cassette elevators to eliminate manual handling.

A central track would shuttle wafers between elevator stations that serviced cassettes and “tee” stations that serviced the process stations. This to some extent helped to reduce breakage, but did not solve the contamination problem. Furthermore, most equipment had manual loading as the standard, with the conveyor and elevators added. These systems were reliable and cheap and served as a good prerogative to automation of wafer handling by the times when 200-mm wafers came into use.

Further progress of the industry accompanied by an increase in the diameter of wafer with 200-mm diameter as a standard for substrates led to drastic changes in principles wafer handling occurred. Driven by ever-decreasing linewidths, tighter cleanliness and throughput requirements, and improvements in robotic technology, the rubber-band conveyor/cassette elevator solution was surpassed by true robotic wafer handling.

The new robotics consisted of polar-coordinate robot arms moving wafers with so-called “end effectors”. In robotic, the end effector is a device or tool connected to the end of a robot arm. For handling semiconductor wafers, an end effector may be made in the form of grippers of the types described, e.g., in U.S. Pat. No. 5,108,140, No. 6,116,848, and No. 6,256,555. More detailed description of these end effectors or grippers will be considered later.

These robots were an improvement over the earlier technology. Since the robot's movements were controlled by microprocessor-based servo controllers and servomotors, it became possible to greatly improve the throughput, reliability, and error handling of the wafer handling systems. For example, a typical rubber-band conveyor and cassette elevator system could handle only tens of wafers per hour, while a three-axis robot could move hundreds. Reliability for robots was increased at least up to 80,000 hours mean time between failures (MTBF) compared to a few thousand hours for the conveyor systems.

Introduction of microprocessor control allowed true unattended equipment operation. Operators could manually load cassettes, and the tool could automatically process full wafer lots. Standards also were improved and introduced into use (see, e.g., SEMI standards). However, these standards helped reduce, but did not eliminate, the confusion involved in the selection and application of robotic wafer handling. For example, there are SEMI standards for cassettes, yet many nonstandard cassettes are used. Another compromise is the need to design semiconductor-manufacturing equipment suitable for accepting a large variety of wafer sizes. This adds unnecessary complexity to equipment design.

Furthermore, many equipment manufacturers built their own robots. Each model had to be adaptable to many different wafer sizes and a variety of cassettes.

Recent transfer to 300-mm wafers evolved new problems associated with much higher final cost of a single wafer (up to several thousand dollars as compared with several hundred dollars for 200 mm wafers) and thus required higher accuracy and reliability of the wafer handling equipment. These problems become even more aggravated for handling double-sided polished wafers, where both sides of the wafer are used for the production of the chip. A specific feature of end effectors intended for handling double-sided polished wafers is that they can touch the wafers only at their edges.

Furthermore, transition to 300 mm wafers made the use of low vacuum unsuitable for holding and handling the wafers. The main reason is that in order to protect the wafer from contamination through the mechanical contact with holding parts of the robot arm, both sides (front or back) of the wafer become untouchable for handling. Another reason is that vacuum holders are not reliable for handling wafers of heavy weight. Thus, the conventional vacuum end effectors appeared to be unsuitable for handling expensive, heavy, and hard-to-grip wafers of 300 mm diameter.

According to Semi Standards, the allowance for the gripping area of the 300 mm wafer should not exceed 3 mm from the edge of the wafer and preferably to be down to 1.5 mm or even less. To reliably hold the wafer and to protect it from breaking during all handling transportation procedures, it is necessary to use a limited holding force of at least at 3 points circumferentially spaced along the edge of the wafer.

There exist a great variety of end effectors with edge grippers for handling thin flat objects such as wafer substrates. Some typical end effectors of the edge-gripping type are described below.

For example, U.S. Pat. No. 6,167,322 issued on Dec. 26, 2000 to O. Holbrooks describes intelligent wafer handling system that removes wafers from the wafer cassette using a thin flat gripper that can slip in between parallelly stacked and spaced wafers and has two proximal stationary posts for contact with the edge on one side of the wafer and one or two short distal rotating fingers on the ends of the sliding rods for contact with the edge on the diametrically opposite side of the wafer. The aforementioned distal rotating fingers are made rotatable in order to turn them into non-gripping position coplanar with the plane of the flat gripper and, hence, parallel to the plane of the wafer for insertion between the wafers in the storage cassette. When during insertion into the cassette the distal finger reaches the extreme position behind the aforementioned diametrically opposite side of the wafer, the distal fingers are turned by 90° relative to the plane of the wafer and shifted in the direction of proximal posts for gripping the wafer at its edge. The wafer is now ready for extraction from the cassette by withdrawing the flat gripper for subsequent transfer of the wafer to the destination, e.g., to a chuck of a processing station.

In the Holbrooks's device the flat edge gripper is inserted into the cassette underneath the wafer. Therefore, in order to place the removed wafer, e.g., to the chuck of a processing station, this chuck should have a special construction with feature that would allow insertion of the wafer to the position suitable for clamping the wafer in the chuck.

For example, the chuck should have wafer-supporting pins, which are moveable in the direction perpendicular to the wafer plane. The wafer is placed by the gripper onto the pins, which are lowered into the wafer clamping position for wafer processing and are raised upon completion of the treatment for picking up the wafer by the edge gripper. Provision of moveable parts such as pins in the vicinity of the wafer may cause contamination of the wafer surface by the products of wear of the moveable parts. Alternatively, a chuck may have profiled recesses for insertion and subsequent removal of the gripper after the wafer has been loaded.

Many other known edge grippers are based on the same principles as the Holbrooks's device with positioning of the gripper underneath the wafer, wafer substrate, hard disk, or a similar flat object. The object is gripped at its edge portion and has contact with the gripping elements at least at three points. See, e.g., U.S. Pat. No. 6,116,848 issued in 2000 to D. Thomas, et al.. U.S. Pat. No. 6,053,688 issued in 2000 to D. Cheng, U.S. Pat. No. 6,256,555 issued in 2001 to P. Bacchi, et al., U.S. Pat. No. 6,485,253 issued in 2002 to J. Adams, et al., etc. The aforementioned devices differ from each other only by the kinematics of the drive for moveable parts, profiles of the gripping elements, and the shape of the gripper itself.

A disadvantage of the wafer handling system of Holbrooks consists in that this apparatus does not provide control of gripping speed at different stages of the gripping cycle.

Another disadvantage of the Holbrooks system consists in that this system does not provide decrease in gripping pressure when the gripper approaches the edge of the wafer with acceleration.

An attempt to solve the aforementioned problems of the prior art was made in U.S. patent application Ser. No. 09/944,605 filed in 2001 by B. Kesil, et al. The precision soft-touch gripping mechanism disclosed in that application has a mounting plate attached to a robot arm. The plate supports a stepper motor. The output shaft of the stepper motor is connected through a spring to an elongated finger that slides in a central longitudinal slot of the plate and supports a first wafer gripping post, while on the end opposite to the first wafer gripping post the mounting plate pivotally supports two L-shaped fingers with a second and third wafer gripping posts on their respective ends. The mounting plate in combination with the first sliding finger and two pivotal fingers forms the end effector of the robot arm, which is thin enough for insertion into a wafer-holding slot of a wafer cassette. The end effector is equipped with force sensors for controlling the wafer gripping force. Several embodiments relate to different arrangements of gripping rollers and mechanisms for control of the gripping force and speed of gripping required for gripping the wafer with a soft and reliable touch.

A specific feature of the mechanism of U.S. patent application Ser. No. 09/944,605 that advantageously distinguishes it from the Holbrooks system is that the proposed mechanism for the first time suggests the use of three moveable fingers with gripping posts at the ends of the fingers that are arranged circumferentially around the periphery of the wafer and that have an independent soft touch at each post.

Experiments showed that mechanism of U.S. patent application Ser. No. 09/944,605 has the lowest level of contamination (which is extremely important for satisfying the clean-room requirements). This is achieved due to the fact that all sliding pairs are isolated from the zone where wafers are located and due to the fact that the distal post is stationary. However, a disadvantage of the stationary post, which has a predetermined height, is that, in order to prevent interference between the post and the wafer, the mechanism requires the use of complicated wafer position detecting sensors. The last-mentioned drawback is solved in the aforementioned Holbrooks system that utilizes a rotatable distal pin, which is turned by 90° for orientation in the plane parallel to the surface of the wafer when the pin is inserted into the slot of the wafer storage cassette. In fact, due to the presence of the notch on the edge of the wafer, in order to prevent interference of the post with the notch, the mechanism should have at least two distal posts. This means that the members of the mechanism located in the zone of wafers have two rotary sliding pairs that are turned at least by 90° and may cause contamination of the wafer with the product of wear.

In order to solve the above problem, the applicants have developed a soft-touch gripping mechanism for flat objects disclosed in aforementioned U.S. patent application Ser. No. 10/719,411 filed by B. Kesil et al., on Nov. 24, 2003 and entitled “Soft-Touch Gripping Mechanism for Flat Objects”. In the mechanism of the last-mentioned patent application, the soft touch is achieved by transmitting the movement of the pusher to the linear fingers through a spring. In order to facilitate insertion of the rotating distal finger into narrow slots between the flat objects, such as semiconductor wafers in the storage cassette, the distal post can be turned by an angle less 90°. Reduced rotary sliding movement minimizes a chance of contamination of the wafer with products of wear.

Analysis of the latest edge grippers for handling delicate objects such as semiconductor wafers or wafer substrates, including those mentioned in aforementioned patent applications of the applicants, reveals the following trends: 1) increase in the speed of gripper movements; 2) decrease in the thickness of the flat gripper (i.e., of the height of the gripper's transverse cross section); 3) increase in the vibration-damping properties of the gripper; 4) maintaining soft touch in gripping under the conditions of increased speed of the gripper; 4) reduction of contamination by wear products. The trends 1) to 4) are interrelated with each other.

Regarding item 1), it should be note that the increase in speed of the gripper movement is dictated by the demand for increase in the productivity of the wafer processing stations and, hence, for reduction in the time required for loading/unloading and transporting of the objects such as wafer substrates, wafers, etc. However, an increase in the speeds of the edge grippers, with and without the objects, is associated with an increase in acceleration of moving parts. Therefore, in order to diminish the forces developed by an accelerated gripper, especially, when it carries an object, and in order to ensure secure hold of the object in the gripper, it is necessary to reduce the mass of the gripper. In other words, the gripper body should be made thinner. On the other hand, the thinner is the gripper's body, the more chances that the gripper will be subject to transverse oscillations, and therefore the gripper should have a vibration-damping structure, as mentioned in item 3). However, an increase in the damping properties should not contradict with a reduced thickness of the gripper body (requirement of Item 2) for insertion into narrow slots. Regarding Item 4), attempts have been made to prevent contamination. For example, U.S. Pat. No. 6,474,712 issued in 2002 to B. Govzman discloses an edge gripper with vertical orientation of the wafer in order to prevent contamination of the lower-level wafers with wear products in a cassette with horizontally arranged wafers. However, the vertically-orientated grippers require additional mechanisms of rotation for placing the wafers into a chuck or the like. This makes the construction of wafer processing equipment more complicated. On the hand, some technological processes and devices may not allow vertical orientation at all. U.S. Pat. No. 6,474,712 demonstrates an attempt to solve the problem associated with contamination that was also mentioned, e.g., in U.S. Pat. No. 5,000,652 issued in 1991 to R. Christensen, et al. In the “Prior-Art” section, the above patent refers to one of IBM edge grippers for handling semiconductor wafers, where the mechanism is disposed over the active surface of the wafer and therefore may cause contamination of the wafer surface. Thus, although a position of the gripper above the object such as a wafer substrate or a wafer is attractive from the point of view of simplicity of object transfer to the chuck and loading to the chuck, none of the overhead grippers known to the applicants found practical application for the reasons described above.

As has been mentioned above, the applicants have partially solved the contamination problem by developing a soft-touch gripping mechanism for flat objects disclosed in aforementioned U.S. patent application Ser. No. 09/944,605, where the level of contamination was reduced to no more than 5 particles per cubic feet in the wafer-handling environment. This result was confirmed by multiple measurements.

Finally, in edge grippers known to the applicants at least the backside of the object is normally brought in surface-to-surface contact with the gripper or with supporting pins, which is undesirable from the point of view of possible contamination.

### OBJECTS AND SUMMARY OF THE INVENTION

It is an object of the present invention to provide a contamination-free edge gripping mechanism for loading/unloading and transferring delicate flat objects that is capable of increasing the speed of gripper movements, has a reduced thickness in a transverse cross section, is characterized by improved vibration-damping properties, maintains soft touch in gripping under the conditions of increased speed, and reduces contamination of the objects by products of wear. It is another object to provide an edge gripper of the aforementioned type that excludes any mechanical contact of the object's face or backside with the flat surface of the gripper or with support pins. It is still another object to provide the edge gripper of the aforementioned type that simplifies loading/unloading of the wafers or wafer substrates into/from chucks of wafer processing stations. It is a further object to provide an edge gripper that makes it possible to simplify the construction of a wafer-holding chuck. Another object is to combine the aforementioned advantages with soft-touch features. It is a further object to provide a method of loading/unloading and transferring delicate flat objects with location of the gripper over the object.

Similar to a conventional edge gripper that during operation is positioned underneath an object, the griping mechanism of the present invention comprises a thin flat body having three gripping fingers that during gripping of a circular flat object such as, e.g., a semiconductor wafer, are arranged circumferentially around the object's edge. However, in contrast to the previous designs, during operation the gripping mechanism of the invention is positioned over the object. In spite of an overhead position, the gripping mechanism is contamination-free and even has much lower level of contamination than the conventional grippers positioned underneath the object. This is achieved by making the body of the gripper in the form of a thin closed casing and by enclosing all moveable parts in the casing. Furthermore, the inner surface of the casing is used as a mounting surface for supporting drive mechanisms for moveable fingers, force control means and other elements required for soft-touch control, etc. In the vicinity of the edge-gripping fingers, the mechanism is provided with soft edge-supporting pads having tapered surfaces for self-alignment and centering of the circular objects in the gripper. The purpose of the pads is to eliminate surface contact between the wafer and the flat gripper by supporting the wafer in the gripper at three or four points of contact with the pads, whereby a small gap is formed between the surface of the gripper body and the surface of the wafer. The overhead position of the gripper with respect to the object makes it possible to simplify the construction of a wafer-holding chuck, e.g., on wafer processing stations. This is because, in contrast to the conventional chucks that cooperate with the edge grippers located underneath the wafer, the chuck suitable for the gripper of the invention may be loaded from above the chuck by simply aligning the gripper with the object relative to the chuck and dropping the object for loading under gravity. Furthermore, in order to eliminate object ejecting pins used in conventional chucks for uplifting the object up to a position required for edge gripping, the gripper of the invention has auxiliary object-uplifting means in the form of vacuum suction ports or in the form of blowing nozzles that generate a vortex effect for uplifting the flat object from the support surface to the level required for edge gripping. The light-weight structure of the gripper makes it possible to increase the speed of movements without risk of generation of vibrations.

### BRIEF DESCRIPTION OF THE DRAWINGS

FIG. 1 is a three-dimensional top view of the gripper of the invention.

FIG. 2 is a three-dimensional bottom view of the gripper of FIG. 1.

FIG. 3 is a view similar to FIG. 1 with the cover removed and with the gripper in a wafer-gripping position.

FIG. 4 is a schematic view of a gripper illustrating drives and kinematics of moving parts for a gripper with a single distal finger.

FIG. 5 is a fragmental longitudinal sectional view of the gripper and wafer along the line that passes through one of the distal fingers and that is parallel to the longitudinal central line of the gripper.

FIG. 6 is a fragmental bottom view of the gripper body that shows position of vortex-generating nozzles.

FIG. 7 is a view in the direction of arrow C in FIG. 4 that shows positions of the distal finger relative to the wafer edge.

FIG. 8 is a three-dimensional view that shows flat gripper inserted into a slot of the cassette between the wafers.

FIG. 9 is a view similar to FIG. 8 but for the embodiment with two distal fingers.

FIG. 10 is a three-dimensional view that illustrates interaction of the gripper of the invention with the wafer chuck.

FIG. 11 is a three-dimensional view that illustrates interaction of the gripper of the invention with a narrow slot of a thermal-treatment apparatus for processing wafers.

### DETAILED DESCRIPTION OF THE INVENTION

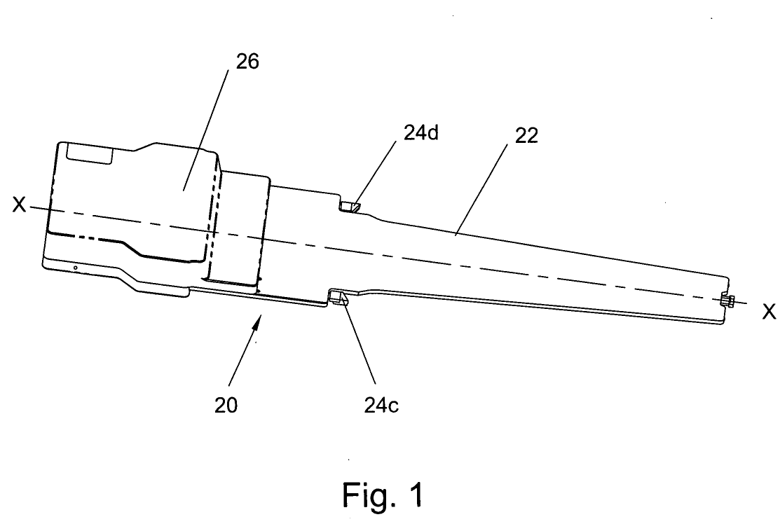

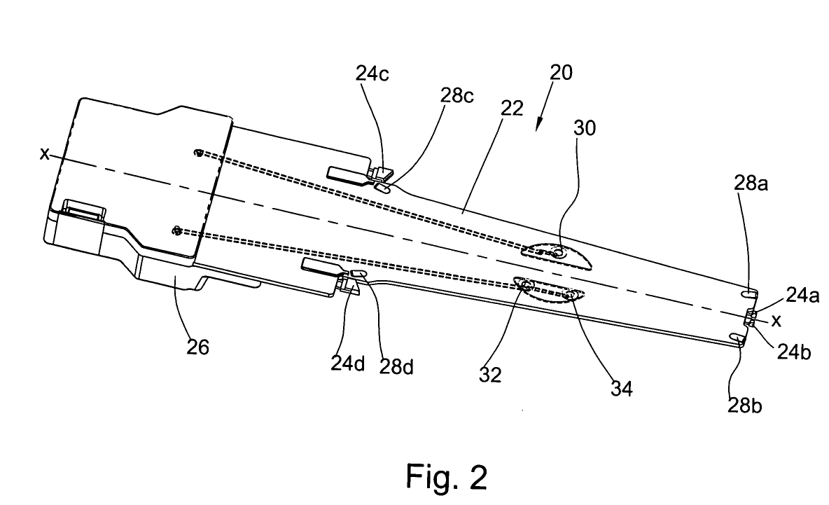

An example of an edge gripper 20 made in accordance with one embodiment of the invention is shown in FIGS. 1 and 2, wherein FIG. 1 is a three-dimensional top view of the gripper 20, and FIG. 2 is a three-dimensional bottom view of the gripper 20. It can be seen that the gripper body is comprised of a thin flat tapered plate 22 that, similar to a conventional edge gripper, supports gripping fingers located on the backside of the gripper body (FIG. 2), such as a pair of rotating distal fingers, 24a, 24b arranged essentially on the longitudinal axis X-X of the gripper 20, and a pair of proximal side fingers 24c, 24d offset from the axis X-X (FIG. 2). The gripper body 22 is a rigid hollow body made from a strong light-weight material such as amorphous aluminum for low temperature applications (not exceeding 300° C.) or titanium for high-temperature applications (exceeding 300° C.). The thickness of the gripper body 22 does no exceed 3 mm. The use of such relative soft materials imparts to the gripper body vibration-damping properties required for damping vibration that otherwise could occur due to increased speeds of movements of the gripping fingers. The gripper body 22 is tapered towards the distal end and has a wider portion on the proximal end that supports drive, control, and actuating mechanisms of gripping fingers, which are described below and which are closed by a protective cover 26 and partially enclosed in the gripper body 22. As shown in FIG. 2, the backside of the gripper body 22 also supports distal aligning pads 28a, 28b that are located in the vicinity of the gripping fingers 24a, 24b and proximal aligning pads 28c and 28d that are located in the vicinity of the gripping fingers 24c, 24d.

In the embodiment shown in FIGS. 1 and 2, the gripper mechanism 22 is also provided with auxiliary suction means located in an intermediate position on the backside of the gripper body 22 and shown in the form of suction openings 30, 32, and 34. At its proximal end, the gripper 20 is connected to an articulating mechanism, such as a robot arm, which is not shown in the drawings.

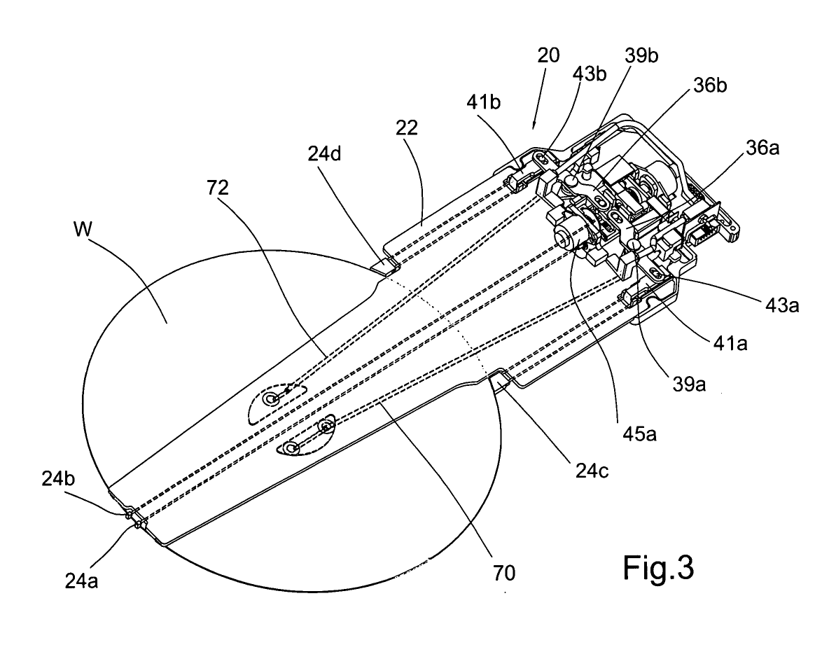

Having described in general the appearance of the gripper 20 with parts and elements that are exposed to the surface of the gripper body 22, let us consider now the aforementioned drive, force control, and actuating mechanisms enclosed in the gripper body 22 and covered by the protecting cover 26. A part of these mechanisms that are mounted on the upper side of the gripper body 22 is shown in FIG. 3, which is a three-dimensional view of the gripper 20 with the protective cover 26 removed. In this drawing, the gripping fingers 24a, 24b, 24c, and 24d are shown in an object-clamping position. In the illustrated embodiment, the object is shown as a semiconductor wafer substrate W.

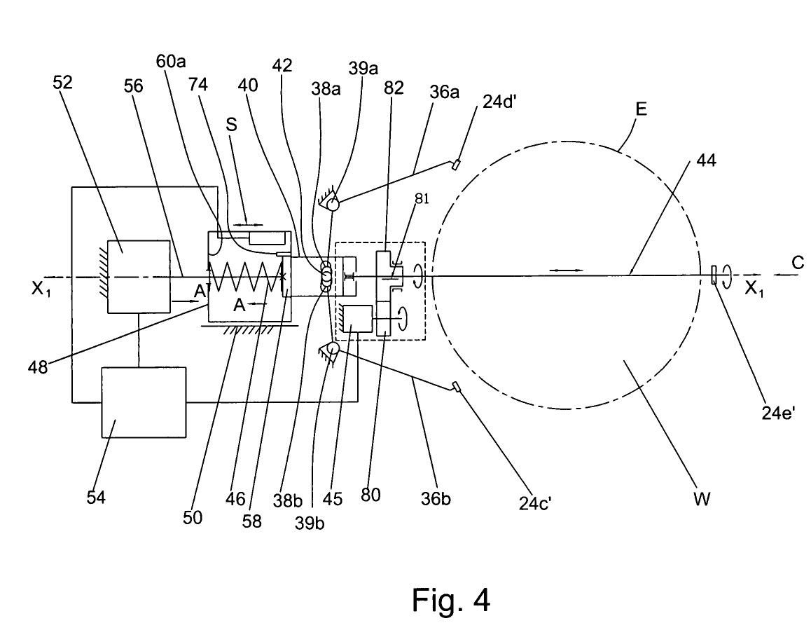

For example only, the gripping mechanism 20 is shown in FIGS. 1-3 as a soft-touch gripping mechanism with finger drive and force control units of the type described in accordance with one of the embodiments of aforementioned U.S. patent application Ser. No. 10/719,411 of the same applicants. The kinematics of the mechanism of FIG. 3 is shown in FIG. 4. However, for the sake of simplicity of the drawing and explanation, the gripping mechanism is shown in FIG. 4 with a single distal finger 24e′. Furthermore, for the same purpose of simplicity, the side gripping fingers 24c′ and 24d′ will be shown in FIG. 4 with swinging gripping motions in the plane coplanar with the plane of the wafer, while in the embodiment of FIGS. 1, 2, and 3, the side gripping fingers 24c and 24d perform linear gripping movements towards the wafer due to connection of the fingers 24c and 24d with sliding rods 41a and 41b that have slot-and-pin connections 43a and 43b with the ends of the respective V-shaped levers 36a and 36b. In the case of the sliding motion of the fingers, it becomes possible to accelerate the movements of the fingers as compared to the rotary motion by reducing the inertial forces inherent in the gripping mechanism with pivotal gripping fingers. Furthermore, it is understood that, similar to one of the embodiments of the aforementioned previous patent application, two distal finger rotating in mutually opposite directions can be easily implemented by using two parallel rods instead of the rod 44 and by rotating these rods in two mutually opposite directions with the use of a pair of engaged gear wheels (not shown) that are secured on the aforementioned rods and are driven into rotation from a motor such as a motor 45 shown in FIG. 4 (motor 45a in FIG. 3).

The actuating mechanism of the gripping fingers 24c′ and 24d′ is comprised of two V-shaped levers 36a and 36bpivotally installed on pins 39a and 39b that are secured in the gripper body 22. External arms of these levers support the aforementioned gripping finger 24c′ and 24d′, while the inner arms, which are closer to the axis X-X, have slots 38a, 38b arranged one above the other. The pin 42 is rigidly connected to a slider 40 which is connected via a compression spring 46 to a sliding frame 48 that slide in a stationary guide 50 in the axial direction X-X of the gripper 20. The pin 42 moves together with a rod 44 that extends along the axis X-X and supports the aforementioned finger 24e′. The gripper body 22 also supports a linear stepper motor 52 with a driver 54. The output shaft of the motor 52 is inserted into the aforementioned sliding frame 48. The output shaft of the stepper motor 52 performs linear motions in the axial direction X-X towards or away from the semiconductor wafer W (FIG. 4) and will be hereinafter referred to as a plunger 56. The free end of the plunger 56 supports a pusher plate 58, which is pressed against the frame 48 by the aforementioned compression spring 46 located between the pusher plate 58 and the end face 60a of the frame 48 opposite to the semiconductor wafer W.

In the embodiment shown in FIGS. 1, 2, 3, the gripper 22 is provided with two rotating distal fingers 24a′ and 24b′ that can be turned in mutually opposite directions, e.g., due to engagement of aforementioned two gear wheels (not shown).

When the stepper motor 52 moves the plunger 56 with the pusher plate 58 linearly towards the semiconductor wafer W or away from the semiconductor wafer W, the spring 46 is decompressed or compressed. When, in the course of the forward movement the pusher plate 58 comes into contact with the end face of the frame 48 nearest to the semiconductor wafer W, the further movement of the plunger 56 is continued together with the frame 48 (in the direction of arrow A) and, hence, with the aforementioned common pin 42 located in the slots 38a and 38b on the ends of the levers 36a and 36b. As a result, the side gripping fingers 24c′ and 24d′ will rotate on their pivot axes 39a and 39b so that the gripping fingers 24d′ and 24d′ are moved away from the edge E of the semiconductor wafer W for expanding the space into which the wafer W can be placed or from which the wafer W can be removed, e.g., by a mechanical arm of a robot (not shown). Meanwhile, the distal gripping post 24e′ that is attached to the distal end of the gripper body 22 (FIGS. 1 and 2) also participates in the outward movement from the wafer W since the first finger 24e′ is rigidly connected to the aforementioned common pin 42 via the rod 44 (FIG. 4).

For gripping the wafer W with soft touch, the linear stepper motor 52 is reversed, the pusher plate 58 begins to move away from the wafer W and compresses the spring 46, whereby a reversing axial force of the pusher plate 58 is transmitted via the spring 46 to the frame 48. The frame 48 commences its movement away from the wafer W together with the common pin 42. The latter slides in the slots 38a and 38b of the levers 36a and 36b, and at the same time turns the fingers 24d′ and 24c′ towards the edge E of the wafer W. The distal post 24e′ also moves inwardly towards the edge E of the wafer W.

Since the gripper 20 of the present invention is located above the wafer W and the movement of its gripping fingers occurs in a plane which is parallel to the plane of the wafer W and is located above the plane of the wafer, instead of uplifting of the gripper that takes place in conventional edge grippers, the flat gripper 20 slightly descends for arranging the gripping fingers 24c′, 24d′ and 24e′ of the embodiment of FIG. 4 or the gripping fingers 24a, 24b, 24d, and 24c of the embodiment of FIGS. 1, 2, and 3 in the plane of the wafer W. The descending movement is carried out by the programmed robot arm, which is not shown in the drawings as its construction is beyond the scope of the present invention.

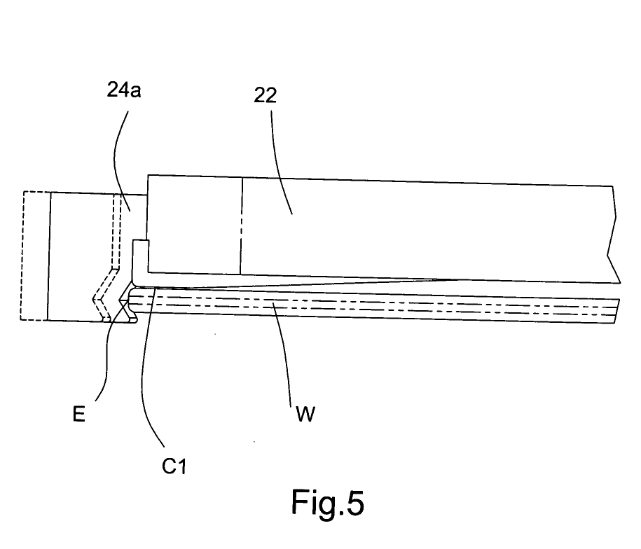

The following description will relate to the embodiment of FIGS. 1, 2, and 3 with two gripping fingers on the distal end of the gripper and with a near movement of the side gripping fingers. As the gripper 20 moves towards the wafer W, its pads 28a, 28b, 28c, and 28d located on the backside of the gripper body 22 come in contact with the peripheral parts of the wafer W, and the latter is self-centered on the tapered surfaces of the pads. This condition is shown in FIG. 5 that is a fragmental longitudinal sectional view of the gripper and wafer along the line that passes through one of the distal fingers, e.g., the finger 24a and that is parallel to axis X-X. It can be seen that contact between the wafer W and the pad 28a, and hence the pads 28b, 28c, occurs at point C1, which is located on the peripheral area of the wafer surface that is allowable for physical contact with the wafer. At the moment of the aforementioned contact the gripper finger 24a, as well as three other fingers, is located in a slightly radially outward position relative to the wafer edge E. In FIG. 5, this outward position of the finger 24a is shown by broken lines. Since all the pads are accurately positioned on a common circumference, the wafer is self-centered. A provision of the pads eliminates surface contact between the wafer and the flat gripper, whereby a small gap is formed between the surface of the gripper body 22 and the surface of the wafer W.

With the continuing movement of the frame, such as the frame 48 in FIG. 4, in the direction away from the wafer, the gripping fingers move towards the wafer edge E and securely grip the wafer in the gripper 20. The gripping position of the finger 24a is shown in FIG. 5 by solid lines. It can be seen that in the illustrated embodiment, the contact surface of the gripping finger has a V-shaped profile, which is shown only as an example. In the above embodiment with the descending of the gripper till contact of the self-centering pads with wafer surface any damages caused by accidental inaccuracies or misplacements may be compensated due to the use of the aforementioned soft-touch mechanism.

The above description related to the case of wafer gripping with descending of the gripper till physical contact of the self-centering pads 28a, 28b, 28c, and 28d with the surface of the wafer W. If necessary, however, the descending movement of the overhead gripper 20 can be significantly reduced or completely eliminated by utilizing the aforementioned suction means with suction openings 30, 32, and 34 shown in FIG. 2. The suction openings 30, 32, and 34 are connected to a source of vacuum, e.g., to a vacuum system, which is normally available at any semiconductor production facility (not shown), via longitudinal channels 70 and 72 shown by broken lines in FIGS. 2 and 3. These channels are connected to the vacuum system via appropriate couplings (not shown) located under the cover 26.

With the use of the aforementioned auxiliary vacuum system, the gripper with the gripping fingers 24a, 24b, 24c, and 24d in radially outward positions, corresponding to the broken-line position of the finger 24a in FIG. 5, is aligned with the position of the of the wafer, and when the vacuum is induced in the narrow space between the surface of the wafer W and the backside of the gripper body 22, air is sucked from the aforementioned space, and the induced low pressure attracts the wafer W towards the gripper 20. As a result, the wafer is placed onto the pads 28a, 28b, 28c, and 28d, and the gripping procedure is completed in the same manner as described above.

If necessary, the vacuum suction force for lifting the wafer towards the gripper can be replaced by generation of a reduced-pressure zone due to the use of a vortex lifting force.

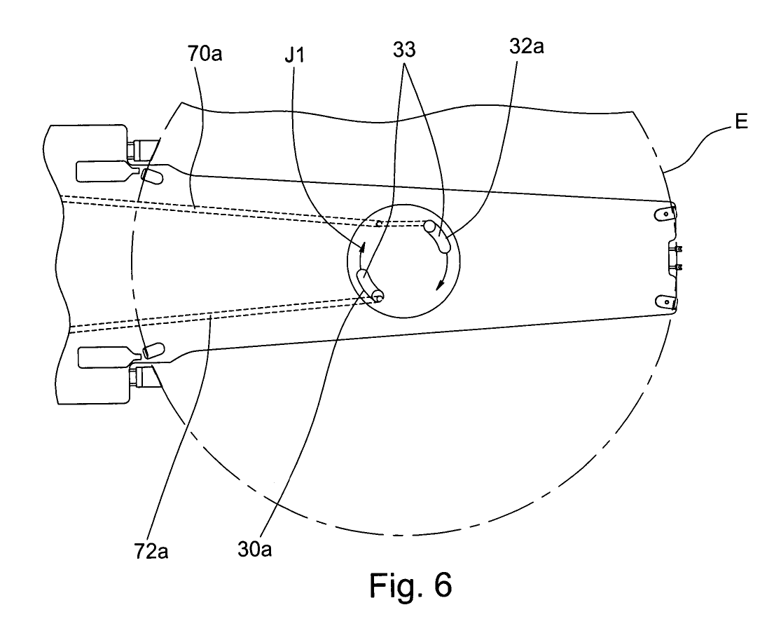

An embodiment that is based on this principle is shown in FIG. 6 that is a fragment bottom view of the flat gripper. In this embodiment, vacuum channels 70 and 72 of the embodiment of FIG. 2 are replaced by channels 70a and 72a that are connected to a compressed air system and supply compressed air to a pair of oppositely directed nozzles 30a and 32a arranged in a circular recess 33 tangentially to an the circumference of this recess. The aforementioned recess 33 is concentric to the position of the wafer W but is located within the boundaries of the gripper body 22. When jets J1 and J2 of compressed air are emitted from the nozzles in the position of the gripper above the wafer W, a difference in circumferential speeds of flows of the emitted air on the peripheral areas of the recess and in the central area of the recess will generate a reduced pressure in the central area of the recess 33 whereby a lifting force will be applied to the wafer W. After the wafer W is lifted and placed onto the pads, the remaining procedure will be the same as described in the previous embodiments.

It should be noted that the aforementioned vacuum and vortex uplifting means do not use any mechanically moving parts that could contaminate the environment in the vicinity of the wafers.

The touch-force is precisely measured and controlled with the use of a special position sensor S (FIG. 4). The sensor S may comprise, e.g., a magnetic sensor (Hall sensor) that consists of a moveable magnetic flag 74 attached to the side of the aforementioned pusher plate 58 and a sensitive member, e.g. a Hall sensor chip 60 that responds to the position of the magnetic flag 74. The Hall sensor S produces an output voltage signal that is proportion to the position of the flag 74 relative to the Hall sensor chip 60. It is understood that an output signal of the Hall sensor S can be used for controlling the driver of the stepper motor 52 and thus for controlling the final soft-touch gripping force. The final soft-touch gripping force corresponds to a predetermined value of an output signal of the Hall sensor S. When this value reaches the one that is set in the controller 54, the latter sends a stopping command to the driver of the stepper-motor 52. Thus the final soft-touch gripping force of the gripping fingers 24c′, 24d′, and 24e′ relative to the edge E of the semiconductor wafer W can be adjusted by setting the controller 54 to a required value.

FIG. 4 shows positions of various parts (i.e., the gripping fingers 24c′, 24d′, and 24e′, the pusher plate 58, and other associated parts) in an open position of the gripper mechanism, i.e., when the gripping fingers 24c′, 24d′, and 24e′ are shifted outward from the edge E of the semiconductor wafer W. In this position, there is no space between the pusher plate 58 and the mating inner end face 76 of the frame 48. In the gripping position, however, a space (not shown) is formed between the pusher plate 58 and the mating inner end face 76 of the frame 48. The space is formed due to retracted movement of the output shaft 56 of the linear stepper motor 52 together with the pusher plate 58 which is retracted from the end face 76 of the frame 48 and compresses the spring 46. The retraction movement stops when the soft-touch gripping force on the respective posts reaches the value set in the controller 54.

In order to facilitate insertion of the distal finger into narrow slots between the flat objects, such as semiconductor wafers in the storage cassette (not shown), the distal post 24e′ can be turned as in the aforementioned patent application Ser. No. 10/719,411, e.g., by less than 75°.

As shown in FIG. 4, the rotating mechanism (which for the sake of simplicity is shown for a single distal finger 24e′ and can be doubled by using aforementioned pair of gear wheels) is comprised of a self-contained reducer that consists of the aforementioned drive motor 45 that supports on its output shaft a gear wheel 80, which is in mesh with a gear wheel 82. The letter has sliding connection with the rod 44 of the distal gripping finger 22e′ on splines or on a guide key 81 so that the gripping finger 24e′ rotates together with the gear wheel 82 and at the same time can slide in the axial direction of the longitudinal axis X-X. Thus, the rotation of the gripping finger 24e′ does not interfere with the gripping action described above.

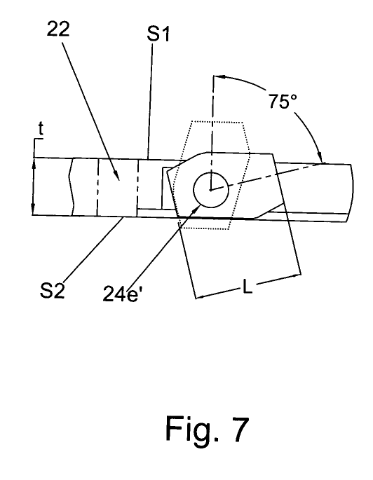

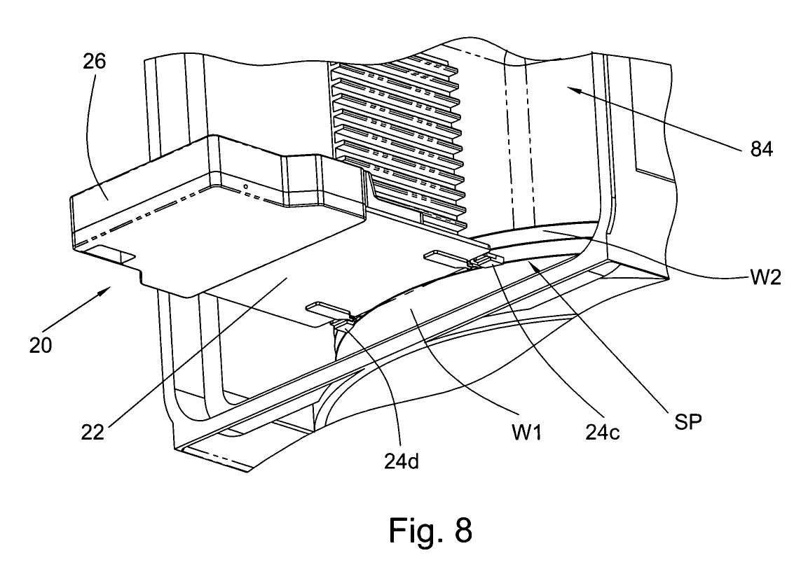

FIG. 7 is a fragmental end view of the distal gripping finger arrangement in the direction of arrow C in FIG. 4 with the distal gripping finger 24e shown in a hidden position for insertion of distal end of the gripper body 22 with the finger 24e′ into a narrow space SP between the adjacent wafers W1 and W2 in the storage cassette 84, as shown in FIG. 8. In other words, in this position (FIG. 7) the distal finger 24e′ is arranged substantially in flush with the upper and lower surfaces S1 and S2 of the flat gripper body 22. Since the body 22 of the gripper 20 has a certain thickness “t”, the distal finger 24e′ may have such a configuration that allows normal gripping conditions with rotation of the gripping finger 24e′ from the position shown in FIG. 7 by solid lines to the position shown by broke lines by an angle substantially less than 90°. For example, as shown in FIG. 7, the gripping finger 24e′ can be turned 75°. If necessary, the rotation angle can be less than 75°, e.g., 60°, 65°, 70°. It is obvious that the smaller is the finger rotation angle, the shorter is the movement and the movement time, and therefore the less is contamination caused by friction in sliding pairs. In other words, in addition to the closed design of the entire gripper, the reduced angle of rotation of the distal finger constitutes further contribution to protection of the wafers and water substrates against contamination.

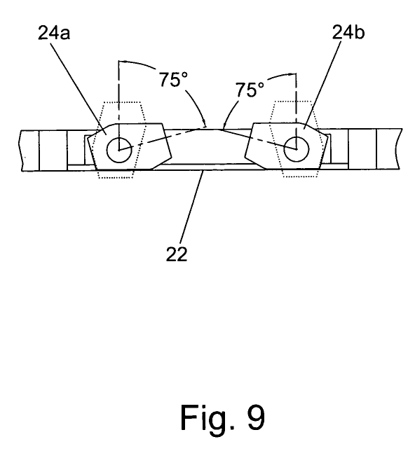

FIG. 9 is a view similar to FIG. 7 but for embodiment of the gripper 22 shown in FIGS. 1, 2, and 3 with two distal rotating fingers 24a and 24b. Both fingers 24 and 24b are shown by solid lines in the hidden positions for insertion into a narrow space and by dotted lines in the wafer gripping positions.

There is one more essential advantage of using the overhead position of the gripper for gripping and releasing the wafer. This advantage is significant simplification in the construction of chucks used in wafer or wafer-substrate processing stations for holding wafers or wafer substrates during processing. It is understood that with the gripper that is located underneath the wafer, during loading to the chuck the edge gripper is located between the wafer and the supporting surface of the chuck. Conventional chucks normally have supporting/ejecting pins onto which the wafer or wafer substrate is placed. Thus, the gripper with the wafer is transferred towards the chuck to a position where the wafer is aligned with the support surface of the chuck, the gripper fingers are moved outward to release the wafer, the latter is placed onto the pins, the gripper is withdrawn from the chuck, and then the pins descend and place the wafer onto the support surface. When after the treatment the wafer has to be removed from the chuck, the wafer is uplifted by means of the aforementioned pins into an elevated position suitable for gripping the wafer with the edge gripper. In other words, the underneath position of the gripper dictates the use of a number of mechanisms that make the chuck complicated in design and expensive to manufacture.

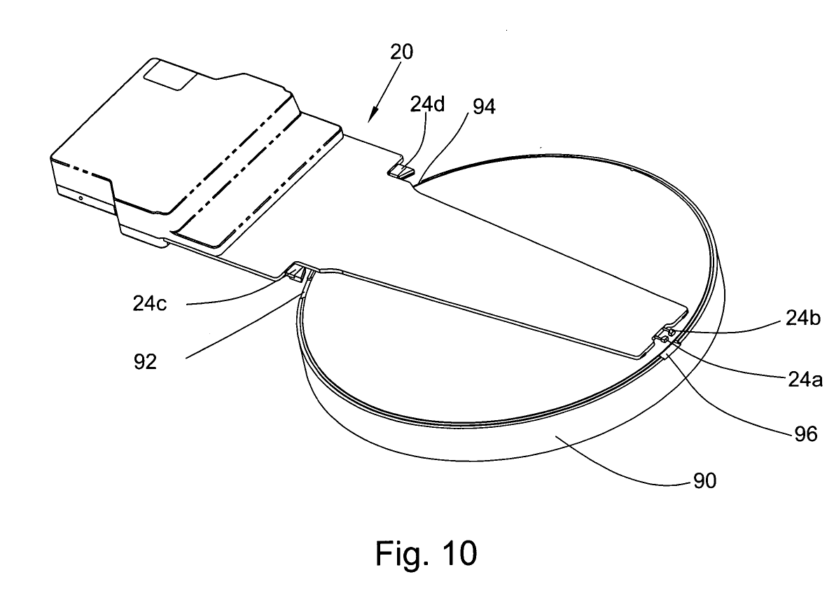

The above problems are easily solved by using the gripper located over the wafer. FIG. 10 shows a chuck 90 of a simplified construction suitable for loading/unloading with the gripper 20 of the invention. The chuck 90 can be made as a simple shallow cup-shaped cylindrical body that has support surface without any pins or necessity of using any lifting mechanisms. It is only needed to provide the chuck with cutouts 92, 94, and 96 for passing the gripping fingers 24a, 24b, 24c, and 24d towards the wafer edges when the fingers are moved radially inwardly for gripping the wafer.

It can be understood from the above description of the gripper that the invention also provides a new method for contamination-free loading/unloading flat objects such as wafers or wafer substrates by providing a thin edge gripper, preferably of a soft-touch type, with the construction that closes the moving parts of drive and control elements and with at least two side gripping fingers and one rotatable distal gripping finger, providing said gripper on backside with tapered supporting pads for the wafer, arranging the gripper over a wafer to be picked up, moving the gripper downward till contact of the peripheral portions of the wafer with the supporting pads but without surface-to-surface contact between the gripper and the wafer, gripping the wafer by moving the fingers towards the wafer edges, and transferring the wafer to the destination.

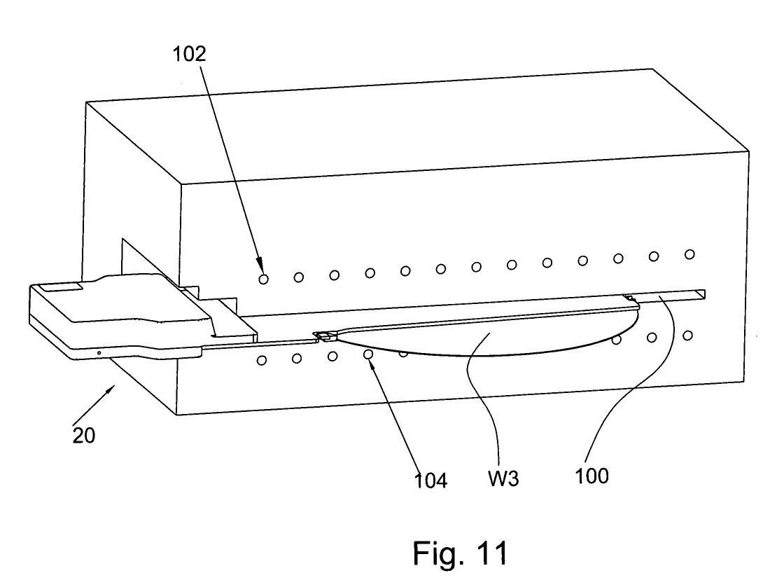

FIG. 11 is a three-dimensional view that illustrates application of the edge gripper 20 of the invention for insertion of a wafer W3 into a narrow slot 100 of a wafer heat-treatment furnace. Reference numerals 102 and 104 designate heating elements of the furnace. A slim design of the gripper body 22 that has a thickness not exceeding 3 mm is important for this application since the narrower is the slot 100, the higher is the uniformity of heat treatment of the wafer.

Thus it has been shown that the invention provides a contamination-free edge gripping mechanism for loading/unloading and transferring delicate flat objects that is capable of increasing the speed of gripper movements, has a reduced thickness in a transverse cross section, is characterized by improved vibration-damping properties, maintains soft touch in gripping under the conditions of increased speed of the gripper, and reduces contamination of the objects by products of wear. The gripper of the invention excludes any mechanical contact of the object's face or backside with the flat surface of the gripper or with support pins, simplifies loading/unloading of the wafers or wafer substrates into/from chucks of wafer processing stations, and makes it possible to simplify the construction of a wafer-holding chuck. Another object is to combine the aforementioned advantages with soft-touch features. It is a further object to provide a method of loading/unloading and transferring delicate flat objects with location of the gripper over the object.

Although the invention has been shown and described with reference to specific embodiments, it is understood that these embodiments should not be construed as limiting the areas of application of the invention and that any changes and modifications are possible, provided that these changes and modifications do not depart from the scope of the attached patent claims. For examples, the gripper body may have different shape and can be made from materials other than those indicated in the specification. The fingers can be driven into linear motion by mechanisms of other types, e.g., by rack-and-gear mechanisms, cams, cranking mechanisms, etc. The gripping force can be controlled by using an “open loop” system (programmed stepper motor counts) or a “closed loop” system motor control (linear encoder, Hall sensor, etc.). The spring may be of a compression type or of an expansion type. The gripping fingers may support at their ends profiled rotating rollers.

What is claimed is:

1. A contamination-free edge gripping mechanism for loading/unloading and transferring flat circular objects, each of said objects having an upper surface and a lower surface, said mechanism comprising:
an elongated flat thin gripper body having a longitudinal axis, a hollow interior, an upper side, and a backside that faces said upper surface during operation of said gripper;
at least two proximal side gripping fingers located on opposite side of said longitudinal axis for gripping engagement with one side of said circular objects and at least one distal gripping finger for gripping engagement with the side of said objects diametrically opposite to said one side, said at least two proximal side gripping fingers and said at least one distal finger being located on said backside of said gripper body; and
at least three object-centering pads, each located in the vicinity of said at least two proximal side gripping fingers and said one distal gripping finger, respectively, said object-centering pads having surfaces tapered towards said edge of said objects and raised above said backside for preventing surface-to-surface contact between said upper side of said objects and said backside of said gripper body.

2. The contamination-free edge gripping mechanism of claim 1, further comprising a rotary drive unit for rotating said at least one distal gripping finger and a linear drive unit for linearly moving said at least two proximal side gripping fingers, each of said at least two proximal side gripping fingers being slidingly installed in said gripper body on sliding links that slide in the direction parallel to said longitudinal axis.

3. The contamination-free edge gripping mechanism of claim 2, further comprising a cover that is attached to said gripper body, said first drive unit and said second drive unit being partially covered by said cover and partially locate in said hollow interior of said gripper body.

4. The contamination-free edge gripping mechanism of claim 1, further comprising uplifting means located on said backside of said gripper body and intended for lifting said objects till contact with said at least three object-centering pads, said uplifting means having no mechanically moving parts.

5. The contamination-free edge gripping mechanism of claim 4, wherein said uplifting means are selected from vacuum suction openings connected to a source of vacuum and vortex-generating means comprising a pair of oppositely directed nozzles that are connected with a source of compressed gas.

6. The contamination-free edge gripping mechanism of claim 2, further comprising uplifting means located on said backside of said gripper body and intended for lifting said objects till contact with said at least three object-centering pads, said uplifting means having no mechanically moving parts.

7. The contamination-free edge gripping mechanism of claim 6, wherein said uplifting means are selected from vacuum suction openings connected to a source of vacuum and vortex-generating means comprising a pair of oppositely directed nozzles that are connected with a source of compressed gas.

8. The contamination-free edge gripping mechanism of claim 3, further comprising uplifting means located on said backside of said gripper body and intended for lifting said objects till contact with said at least three object-centering pads, said uplifting means having no mechanically moving parts.

9. The contamination-free edge gripping mechanism of claim 4, wherein said uplifting means are selected from vacuum suction openings connected to a source of vacuum and vortex-generating means comprising a pair of oppositely directed nozzles that are connected with a source of compressed gas.

10. The contamination-free edge gripping mechanism of claim 1, further provided with a soft-touch control mechanism attached to said gripper body and provided with touch-force control sensor for controlling a gripping force applied from said at least two proximal side gripping fingers and at least one distal gripping finger.

11. The contamination-free edge gripping mechanism of claim 3, further provided with a soft-touch control mechanism attached to said gripper body under said cover, said soft-touch control mechanism having a touch-force control sensor for controlling a gripping force applied from said at least two proximal side gripping fingers and at least one distal gripping finger to said edge of said circular objects.

12. The contamination-free edge gripping mechanism of claim 2, wherein said rotary drive unit comprises: a rod that extends along said longitudinal axis and has a distal end that rigidly supports said at least one distal gripping finger and a proximal end; a drive motor that is installed on said gripper body and is connected to said proximal end via transmission means that transmit rotation to said rod but allow axial motions of said proximal end of said rod relative to said transmission means; and wherein said linear drive comprising: a linear drive motor; a sliding frame that is slidingly installed on said gripper body and moved by said linear-drive motor in the direction of said longitudinal axis together with said rod; a pin rigidly connected to said sliding frame; and a pair of V-shaped levers pivotally installed on said gripper body, each of said V-shaped levers having one arm connected to said pin via a first-pin-and-slot connection and a second arm connected to one of said sliding links via a second pin-and-slot connection.

13. The contamination-free edge gripping mechanism of claim 10, wherein said rotary drive unit comprises: a rod that extends along said longitudinal axis and has a distal end that rigidly supports said at least one distal gripping finger and a proximal end; a drive motor that is installed on said gripper body and is connected to said proximal end via transmission means that transmit rotation to said rod but allow axial motions of said proximal end of said rod relative to said transmission means; and wherein said linear drive comprising: a linear drive motor; a sliding frame that is slidingly installed on said gripper body and moved by said linear-drive motor in the direction of said longitudinal axis together with said rod; a pin rigidly connected to said sliding frame; and a pair of V-shaped levers pivotally installed on said gripper body, each of said V-shaped levers having one arm connected to said pin via a first-pin-and-slot connection and a second arm connected to one of said sliding links via a second pin-and-slot connection.

14. The contamination-free edge gripping mechanism of claim 11, wherein said rotary drive unit comprises: a rod that extends along said longitudinal axis and has a distal end that rigidly supports said at least one distal gripping finger and a proximal end; a drive motor that is installed on said gripper body and is connected to said proximal end via transmission means that transmit rotation to said rod but allow axial motions of said proximal end of said rod relative to said transmission means; and wherein said linear drive comprising: a linear drive motor; a sliding frame that is slidingly installed on said gripper body and moved by said linear-drive motor in the direction of said longitudinal axis together with said rod; a pin rigidly connected to said sliding frame; and a pair of V-shaped levers pivotally installed on said gripper body, each of said V-shaped levers having one arm connected to said pin via a first-pin-and-slot connection and a second arm connected to one of said sliding links via a second pin-and-slot connection.

15. The contamination-free edge gripping mechanism of claim 1, wherein said gripper body, at least between said at least two proximal side gripping fingers and at least one distal gripping finger has a thickness not exceeding 3 mm.

16. The contamination-free edge gripping mechanism of claim 15, wherein said gripper body is made from a material selected from aluminum and titanium.

17. The contamination-free edge gripping mechanism of claim 2, wherein said gripper body, at least between said at least two proximal side gripping fingers and at least one distal gripping finger has a thickness not exceeding 3 mm.

18. The contamination-free edge gripping mechanism of claim 17, wherein said gripper body is made from a material selected from aluminum and titanium.

19. The contamination-free edge gripping mechanism of claim 7, wherein said gripper body, at least between said at least two proximal side gripping fingers and at least one distal gripping finger has a thickness not exceeding 3 mm.

20. The contamination-free edge gripping mechanism of claim 19, wherein said gripper body is made from a material selected from aluminum and titanium.

21. The contamination-free edge gripping mechanism of claim 8, wherein said gripper body, at least between said at least two proximal side gripping fingers and at least one distal gripping finger has a thickness not exceeding 3 mm.

22. The contamination-free edge gripping mechanism of claim 21, wherein said gripper body is made from a material selected from aluminum and titanium.

23. A method for loading/unloading flat circular objects without contamination of said flat objects comprising the steps of:
providing a contamination-free edge gripping mechanism for loading/unloading and transferring a flat circular object having an upper surface and a lower surface, said mechanism comprising: an elongated flat thin gripper body having a longitudinal axis, a hollow interior, an upper side, and a backside that faces said upper surface during operation of said gripper; at least two proximal side gripping fingers located on opposite side of said longitudinal axis for gripping engagement with one side of said circular object and at least one distal gripping finger for gripping engagement with the side of said object diametrically opposite to said one side, said at least two proximal side gripping fingers and said at least one distal finger being located on said backside of said gripper body and having drive means located in said hollow interior; and at least three object-centering pads, each located in the vicinity of said at least two proximal side gripping fingers and said at least one distal gripping finger, respectively, said object-centering pads having surfaces tapered towards said edge of said object and raised above said backside for preventing surface-to-surface contact between said upper side of said circular object and said backside of said gripper body;
arranging said gripper over said flat circular object;
causing a relative motion between said circular object and said backside of said gripper body in the direction towards each other till contact of said circular object with said upper surface of said circular object but without surface-to-surface contact between said backside of said gripper body and said upper surface;
causing movement of said at least two proximal side gripping fingers and said at least one distal gripping finger towards said edge of said circular object;
edge-gripping said circular object; and
transferring said circular object to the destination.

24. The method of claim 23, wherein said step of causing a relative motion is lifting said circular object towards said backside of said gripper body by generating an uplifting force due to a reduced pressure developed between said backside and said upper surface, said reduced pressure being generated by providing on said backside suction openings connected to a source of vacuum.

25. The method of claim 23, wherein said step of causing a relative motion is lifting said circular object towards said backside of said gripper body by generating an uplifting force due to a reduced pressure developed between said backside and said upper surface, said reduced pressure being caused by generating a vortex of gaseous flows on a portion of said backside located substantially over the central part of said circular object.
